(19) United States
(12) Patent Application Publication
(10) Pub. No.: US 2014/0018340 A1
(43) Pub. Date: Jan. 16, 2014

(54) Insulin Mimetic Active Comprising Oxodiperoxo Vanadates and a Pharmaceutical Composition Obtained Thereof

(71) Applicants: Mihir K. Chaudhuri, Assam (IN); Sahid Hussain, Patna (IN); Saitanya Bharadwaj, Assam (IN); Upasana Bora Sinha, (IN); Dhrubajyoti Talukdar, (IN); Subeer Suhash Majumdar, New Delhi (IN); Sushmita Bhattacharya, Santiniketan (IN); Suman Dasgupta, Santiniketan (IN); Rakesh Kundu, Santiniketan (IN); Samir Bhattacharya, Santiniketan (IN); Shelley Bhattacharya, Santiniketan (IN); Abul Usmani, New Delhi (IN)

(72) Inventors: Mihir K. Chaudhuri, Assam (IN); Sahid Hussain, Patna (IN); Saitanya Bharadwaj, Assam (IN); Upasana Bora Sinha, (IN); Dhrubajyoti Talukdar, (IN); Subeer Suhash Majumdar, New Delhi (IN); Sushmita Bhattacharya, Santiniketan (IN); Suman Dasgupta, Santiniketan (IN); Rakesh Kundu, Santiniketan (IN); Samir Bhattacharya, Santiniketan (IN); Shelley Bhattacharya, Santiniketan (IN); Abul Usmani, New Delhi (IN)

(21) Appl. No.: 14/007,506

(22) PCT Filed: Jun. 9, 2011
(86) PCT No.: PCT/IN2011/000386

§ 371 Date: Sep. 25, 2013

(30) Foreign Application Priority Data
Mar. 25, 2011 (IN) 401/KOL/2011

(51) Int. Cl. C07F 9/00

(52) U.S. Cl. CPC C07F 9/005
USPC 514/184; 548/403

(57) ABSTRACT

A pharmaceutically acceptable peroxovanadium(v) amine product, DmpzH[VO(02)2](Dmpz)], and its oral as well as injectable use for the treatment of Diabetes mellitus, wherein the said therapeutically stable compound is obtained by reacting V205 or vanadate with hydrogen peroxide and the amine, dimethylpyrazole (Dmpz), at pH 5.5 and temperature 0-4° C. DmpzH[VO(02)2](Dmpz)] is thus poised as a versatile insulin mimic adapted for targeting insulin signaling, stimulating adipogenesis, abrogating insulin stimulated down stream signals thereby lowering the incidence of insulin resistance and type-2 diabetes.

### FIELD OF INVENTION

The present invention relates to a pharmaceutically acceptable peroxovanadium(v) amine product, DmpzH[VO(O₂)₂](Dmpz)], and its oral as well as injectable use for the treatment of Diabetes mellitus. The therapeutically stable compound is obtained by reacting V₂O₅ or vanadate with hydrogen peroxide and the amine, dimethylpyrazole (Dmpz), at pH 5.5 and temperature 0-4° C. The insulin mimetic product presents a broad spectrum of physiological activities augmenting insulin signaling pathway, over expression of PPARγ and inhibition of Fetuin-A expression. DmpzH[VO(O₂)₂](Dmpz)] is thus poised as a versatile insulin mimic adapted for targeting insulin signaling, stimulating adipogenesis, abrogating insulin stimulated down stream signals thereby lowering the incidence of insulin resistance and type-2 diabetes. These manifestations result from the co-operative interaction of the aforesaid physiological pathways.

### BACKGROUND ART

Diabetes mellitus refers to a chronic metabolic disorder in which utilization of carbohydrate is impaired. This is caused by the absolute relative efficiency of insulin (the hormone which regulates the body's glucose level and metabolism) and is characterized by the elevated level of plasma glucose or hyperglycemia in the fasting state or after administration of glucose during an oral glucose tolerance test. There are two forms of diabetes, known as type1 or insulin dependant diabetes mellitus (IDDM) and type2 or non insulin dependant diabetes mellitus (NIDDM). Patients with type 1 diabetes produce very little or no insulin where as those with type 2 diabetes often have plasma insulin levels that are the same or even higher compare to non diabetic subjects. Type2 diabetic patients with elevated plasma levels exhibit a developed resistance to the insulin stimulating effect on glucose and lipid metabolism in the main insulin sensitive tissues i.e., muscles, liver and adipose tissues. This resistance to the insulin responsiveness results in downregulation of insulin signaling molecules, defects in carbohydrate metabolism, and storage and metabolism of lipid etc. Insulin resistance and diabetes cause dysfunction of cells including apoptosis.

Treatment regime of diabetes includes daily insulin injection in case of type1 diabetes and treatment of type 2 diabetes include a number of oral hypoglycemic agents, like sulfonylureas, biguanides, those increased insulin level and troglitazones etc. both individually or in a combination therapy, depending upon the individual need to attain normoglycemia. However, these treatments fail to achieve stringent metabolic control in mice more than 50% of type2 diabetics. The aforesaid limitations demand search for novel anti diabetic agents that mimic or enhance the activity of insulin as well as protect against diabetic complications.

Vanadium has been found to be a potential anti diabetic agents since 1980′ Heyliger et al, 1985 but hitherto it has not reach the clinic practice. Compounds of vanadium have been found useful case of both type1 and type2 diabetes as they can mimic as well as enhance the activity of insulin both in vivo and in vitro.

Vanadium compounds have been reported to have insulin enhancing properties, most notably when administered orally (a rout via which insulin is not so active) but the gastrointestinal absorption of vanadium is usually poor and depends on the chemical nature, solubility and speciation of the specific metal ion complex. Reportedly, vanadate NaVO₃ exerts insulin like actions in intact cells and has been considered as an important probe to relate to insulin in studies of mechanism of action. Vanadate stimulates receptor tyrosine kinase and a potential inhibitor of phosphotyrosine protein phosphatases resulting improvement of insulin action. It produces insulin like stimulation of adipocyte glucose oxidation and deoxyglucose transport.

It has been demonstrated that vanadate enhances the glycogen synthase activation in rat adipocyte as has been observed with insulin. Further, the enhanced phosphorylation of the 95,000 Dalton subunit of the adipocyte insulin receptor by vanadates may help carbohydrate metabolism in general. Vanadate, however, differs from insulin in that it does not affect phosphorylation state of serine residues of the insulin receptor. Thus, despite similarities in the action of insulin and vanadate, some specific differences might as well exist.

Generally 3 different classes of vanadium containing compounds seem to be known for their potential as well insulin mimetic agents:

i) Inorganic salts of VO₄³⁻, VO₃⁻, VO²⁺
ii) Peroxyvanadate(v) complexes, [VO (O₂)(L-L′)(H₂O)]ⁿ⁻ (n=0,1) and [VO(O₂)(L-L′)]ⁿ⁻
iii) Chelated vanadium (IV) complexes. These are well reviewed in the art as witnessed for example by Chemical Rev., 1999, 99, 2561-71.

Reference is made to J. Am. Chem. Soc., 1997, 119, 5447-48. Wherein the synthesis and characterization of a new diperoxovanadium(V) complex containing imidazole coligant with equal or greater or greater insulin mimetic potency than previously described peroxovanadium compound or bis[malto(ato)oxovanadium(IV)] were reported. The preparation requires very stringent condition (−20° C.), and compound is stable as a solid at 4° C. It has been reported in Int. J. Pharma., 1999, 183, 117-23 that transdermally delivered peroxovanadium containing 1,10-phenanthroline ligand can lower blood glucose level in diabetic rats.

Attention is drawn to Mol Cell. Biochem., 2002, 233, 139-43 wherein BMOV has been used to increase GLUT4 in diabetic rat skeletal muscle. This is the first report to claim a direct effect of vanadium on the regulation of GLUT4 expression in diabetic animals in vivo.

Reference is made to Chin. Med. J., 1997, 110, 715-19 wherein some effects of Peroxovanadate (v) complexes contg. Nicotinic acid co ligand on reducing glycemia in diabetic rats and translocation of glucose transporter has been demonstrated. Further work required on this. Important is also refer to J. Inorg. Biochem., 2009, 103, 554-58, wherein a view to the future of vanadium treatment of type2 diabetes has been presented to be more promoting than ever.

Reference is made Patent No. WO200548739 wherein a vanadium (V) ion contg. agent has been reported for improving sugar, lipid and/or nitrogen metabolic errors.

References may be made to U.S. Pat. No. 6,414,029 wherein vanadium complexes of monhydroxamates in combination with administration of insulin have been used to show a decrease in blood glucose level of STZ rats.

Citation is made to U.S. Pat. No. 6,287,586 wherein pharmaceutical compositions of vanadium biguanide complexes have been disclosed. Typically an amount of 3% gum Arabic was used as a carrier. Experiments were performed on STZ-diabetic rats.

Provided in U.S. Pat. No. 5,866,563 are vanadium compositions for using the treatment of hypertension, obesity and diabetes, particularly improved oral compositions comprising oxovanadium (IV) chelates of monoprotic, bidentate oxygen, nitrogen coordinating ligands esp. kojic acid, maltol and ethylmaltol 3% acacia is used as the carrier. BMOV is clearly shown to be superior in blood glucose reducing effect.

Reference is made to U.S. Pat. No. 5,527,790 wherein bis(maltolates) oxovanadium Hs been reported for the treatment of elevated blood sugar. Here again 3% acacia is used as the carrier. The compound BMOV has been shown to be effective in reducing the elevated plasma glucose levels. US Patent No. US2008227809 describes the invention of compounds and pharmaceutical composition for treating human type1 and type2 diabetes, esp. insulin resistant diabetes. The compound is based on arylalkalamine vanadium(V) salts.

Attention is drawn to US Patent No. US20040224031 wherein combinations of amine and vanadium (IV)/(V) compounds have been described for the prevention of diabetes mellitus. Exogenously added hydrogen peroxides (H₂O₂) has been shown to stimulate hexose transport. Involvement of peroxovanadium intermediate is likely to be responsible for enhanced activity. Reference is made to a rather recent Patent No. JP2008201705 wherein anti diabetic agent containing mononuclear or binuclear complex of VO²⁺ and/or Zn²⁺. The complex has been claimed to be useful as anti diabetic drug having insulin like effect Two Chinese Patents CN1481799 AND CN1481800 are drawn attention to where in dim alto/vanadium complex in the form of tablet, granule or capsule has been reported as medicine for the treatment of diabetes. The present invention is an extension of U.S. Pat. No. 5,300,496. Formulations based on vanadium biguanide complex constitute the subject of claims of four Chinese Patents: CN1476828, CN1471912, CN1457773, CN 1471911 and CN 1460472. Several auxilaries have also been used there in as suspension agent, filming materials, transdermal absorptions accelerant or softening agent.

Reference is made to Chinese Patent No. CN 101229218 where in a composition, for the treatment of diabetes, comprising vanadium picolinate, kudza root extract, folium ginkgo extract, vitamins, biotin, lyophilized royal jelly powder, bee pollen, zinc picolinate and chromium picolinate has been described. The invention is claimed to be useful for treating and preventing diabetes. Chinese Patent No. CN 101024660 describes preparation, crystallographic characterization and potential application of a new diperoxovanadium complex to treat diabetes mellitus.

The vanadium in its +5 oxidation state in combination with a bio-compatible ligand and peroxide, appears to be one of the best combinations to provide most effective target specific transportation for inducing insulin release and augmenting adipogenesis. These are the novel dimension of the present application.

### OBJECTS OF THE INVENTION

It is thus the basic object of the present invention to provide for a therapeutically active insulin mimetic which would on one hand trigger insulin signaling pathway, stimulate adipogenesis, reduce NF-KB expression in insulin target cells and inhibit fetuin-A thus being effective in ameliorating type 1 and type 2 diabetic conditions and on the other hand would be highly stable to benefit therapeutically stable and active applications/formulations involving the same for treatment of such conditions.

Another object of the present invention is to provide for the facile synthesis, isolation and characterization of therapeutically active vanadium based insulin mimetic that would be adapted to trigger insulin signaling pathway, stimulate adipogenesis, inhibit NF-κB and fetuin-A expression, which said activities would cooperatively interact to ameliorate type 1 and type 2 diabetic conditions.

Another object of the present invention is to provide for a vanadium based compound that would be adapted to increase the uptake of glucose by insulin target cells through the translocation of glucose transporter 4 (Glut 4) to the cell membrane.

Yet another object of the present invention is to provide for temperature stable vanadium based insulin mimetic with improved shelf life that would be stable in formulations thereby leading to stable pharmaceutical compositions of an orally administered anti-diabetic compound.

Still another object of the present invention is to provide for the said temperature stable vanadium based insulin mimetic that would be highly sensitive in inducing insulin like activity at a much lower dose.

A further object of the present invention is directed to providing storage and therapeutically stable pharmaceutical compositions involving a stable insulin mimetic active.

Yet further object of the present invention is directed to the development of a vanadate compound as an active ingredient for the manufacture of a medicament for treating Diabetes Mellitus that includes both Type 1 and type 2 diabetic conditions and develop methods of treatments for both Type 1 and type 2 diabetic conditions involving such active ingredient.

### SUMMARY OF THE INVENTION

Thus according to the basic aspect of the present invention there is provided an insulin mimetic active comprising oxodiperoxo vanadates with vanadium in +5 oxidation state in combination with a bio-compatible ligand and peroxide favouring for an effective target specific transportation for inducing insulin release and augmenting adipogenesis.

According to a preferred aspect of the invention there is provided the said insulin mimetic active wherein said oxodiperoxo vanadates are selected from DmpzH[VO(O₂)₂](Dmpz)], K[VO(O₂)₂(dmpz)], Na₂[V₂O₂(O₂)₄(dmpz)] or other pharmaceutically acceptable salts of the said vanadates preferably DmpzH[VO(O₂)₂](Dmpz)], wherein said (dmpz) is 3, 5 dimethylpyrazole.

Advantageously, the insulin mimetic active of the present invention is stable in aqueous solution at room temperature for upto 10 days and at 4° C. in ordinary refrigerator for upto six months without any loss of insulin mimetic activity.

In another aspect of the present invention there is provided the said active insulin mimetic which is capable of anyone or more of:

(i) effectively reducing the blood glucose level (p<0.01) in hyperglycemic indications including type 2 diabetic db/db mice having very high blood sugar level even of 600 mg/dl;
(ii) stimulating insulin signaling pathway starting from the stimulation of insulin receptor tyrosine kinase to IRS-1, PI3K and PDK-1 eventually leading to the activation of PKB/Akt and Glut4 in skeletal muscles cell line with the same dose as insulin thus indicative of equipotential insulin like activity;
(iii) stimulating the uptake of [³H]-2 deoxyglucose (2-DOG) in skeletal muscles cells in similar capacity as that of insulin thereby indicative of equipotential insulin like activity;
(iv) inducing Glut4 translocation from cytosol to cell membrane thereby facilitating the entry of glucose into the cells in skeletal muscles cell line in the same dose as of insulin indicative of equipotential insulin like activity even in the total absence of insulin;
(v) augmenting the expression of crucial adipogenic factors—C/EBPβ and PPARγ so as to regulate the differentiation of preadipocytes to mature adipocytes thereby stimulating adipogenesis/adipogenic activity by enhancing accumulation and storage of lipid droplets in adipocytes resulted due to increased lipid uptake thereby reducing the lipid from circulation that prevent the development of insulin resistance; and
vi) significantly reducing fetuin-A expression thus blocking fetuin-A inhibitory action thereby preventing endogenous Fetuin-A responsive damage to adipocyte function indicative of remarkable reduction in insulin resistance.

In yet another aspect of the present invention, a pharmaceutical composition is provided comprising

(i) insulin mimetic active comprising of oxodiperoxo vanadates with vanadium in +5 oxidation state in combination with a bio-compatible ligand and peroxide; and
(ii) one or more pharmaceutically effective amount of any pharmaceutically acceptable carrier.

More advantageously, in the said insulin mimetic active the said oxodiperoxo vanadates are selected from DmpzH[VO(O₂)₂](DmPz)], K[VO(O₂)₂(dmPz)], Na₂[V₂O₂(O₂)₄(dmpz)] or other pharmaceutically acceptable salts of the said vanadates preferably DmpzH[VO(O₂)₂](Dmpz)], wherein said (dmpz) is 3, 5 di methyl pyrazole.

Preferably, a pharmaceutical composition is provided in orally administrable form of drenches (aqueous or non-aqueous solutions or suspensions), tablets, boluses, powders, granules, solutions, capsules and pastes for application through oral route.

Also, a pharmaceutical composition is provided in parenterally administrable form including subcutaneous, intramuscular or intravenous injection preferably as a sterile solution or suspension.

In yet another aspect of the present invention there is provided a method of manufacture of the said insulin mimetic active comprising the steps of:

(a) providing a clear pre-cooled solution of vanadium pentaoxide and hydrogen peroxide; (b) adding dimethylpyrazole to the abovesaid pre-cooled and clear solution and stirring under ice-cold condition; and (c) adding alcohol to the said solution to thereby obtain the said insulin mimetic active therefrom.

In a preferred aspect there is provided the said method of manufacture of the insulin mimetic active wherein the said step of obtaining the said insulin mimetic active comprises the steps of:

(a) providing a suspension of vanadium pentaoxide in water; (b) adding 40-45% hydrogen peroxide solution to the said suspension under pre-cooled condition of 0° C. and stirring until the complete dissolution of said vanadium pentaoxide to yield a reddish-brown clear solution; (c) adding dimethylpyrazole to the said clear solution maintaining the ratio of V:dmpz of about 1:2.4 and the pH of from 5-6 and stirring for about 3 hours under ice cold condition; (d) adding alcohol preferably ethanol to precipitate the said insulin mimetic active therefrom.

In another aspect a method of stimulating insulin signalling pathway is provided starting from the stimulation of insulin receptor tyrosine kinase to IRS-1, PI3K and PDK-1 eventually leading to the activation of PKB/Akt and Glut4 in a mammal in need thereof in classic insulin target cell such as skeletal muscle cells comprising administering to the said mammal in therapeutically effective formulation and amount of the said insulin mimetic active.

In yet another aspect a method of inducing Glut4 translocation from cytosol to cell membrane is provided thereby facilitating the entry of glucose into the insulin target cells in a mammal in need thereof comprising administering to said mammalian cells a therapeutically effective formulation and amount of the said insulin mimetic active ingredient.

In still another aspect a method of preventing insulin resistance for the treatment of type-2 diabetes in a mammal in need thereof is provided by augmenting the expression of crucial adipogenic factors—C/EBPβ and PPARγ adapted to regulate the differentiation of preadipocytes to mature adipocytes and also thereby stimulating adipogenic activity by enhancing accumulation and storage of lipid droplets in adipocytes leading to increased lipid uptake thereby eliminating the lipid from circulation comprising administering to the said mammal in therapeutically effective formulation and amount of the said insulin mimetic active.

In another aspect a method of reducing insulin resistance in classic insulin target cells of a mammal in need thereof is provided through the reduction of fetuin-A expression thus blocking fetuin-A inhibitory effect on insulin activity preventing endogenous Fetuin-A responsive damage to adipocyte function comprising administering to the said mammal in therapeutically effective formulation and amount of the said insulin mimetic active.

Advantageously the use of pyrazole ligated oxodiperoxo-vanadate compound as an active ingredient for the manufacture of a medicament for treating Diabetes Mellitus including Type 1 and type 2 diabetic conditions is provided by way of the present invention.

The details of the invention, its objects and advantages are illustrated in a greater detail in relation to the non-limiting exemplary illustration as set forth hereunder.

### DETAILED DESCRIPTION OF THE INVENTION

As discussed hereinbefore, the present invention provides for insulin mimetic active comprising oxodiperoxo vanadates with vanadium in +5 oxidation state in combination with a bio-compatible ligand and peroxide and its oral as well as injectable forms for the treatment of Diabetes mellitus that is adapted to provide for an effective target specific transportation for inducing insulin release and augmenting adipogenesis.

The said oxodiperoxo vanadates as insulin mimetic actives are selected from DmpzH[VO(O₂)₂](Dmpz)], K[VO(O₂)₂(dmpz)], Na₂[V₂O₂(O₂)₄(dmpz)] or other pharmaceutically acceptable salts of the said vanadates preferably DmpzH[VO(O₂)₂](Dmpz)], wherein said (dmpz) is 3, 5 dimethylpyrazole. The present invention also relates to its process of synthesis and isolation, that is stable for upto six months at 4° C. Advantageously, the said compound of the invention is found to possess on one hand the much required strong insulin mimetic property and also on the other hand eliminate the limitations of stability of vanadium compounds for desired therapeutic activity and can also be desirably stored at room temperature. The said therapeutically stable vanadate compound is obtained by reacting V₂O₅ or vanadate with hydrogen peroxide and the amine, dimethylpyrazole (Dmpz), at pH 5.5 and temperature 0-4° C. The insulin mimetic product thus obtained presents a broad spectrum of physiological activities augmenting insulin signaling pathway, over expression of PPARγ and inhibition of Fetuin-A expression and is thus poised as a versatile insulin mimic adapted for targeting insulin signaling, stimulating adipogenesis, abrogating insulin stimulated down stream signals thereby lowering the incidence of insulin resistance and type-2 diabetes. The aforesaid manifestations result from the co-operative interaction of the aforesaid physiological pathways.

The term “pharmaceutically acceptable salts/derivatives thereof” in this respect, includes the relatively non-toxic, inorganic and organic acid addition salts of compounds of the present invention. These salts can be prepared in situ during the final isolation and purification of the compounds of the invention, or by separately reacting a purified compound of the invention in its free base form with a suitable organic or inorganic acid, and isolating the salt thus formed.

The phrase “pharmaceutically acceptable carrier” as used herein means a pharmaceutically acceptable material, composition or vehicle, such as a liquid or solid filler, diluent, excipient, solvent or encapsulating material, involved in carrying or transporting the subject active agents from one organ, or portion of the body, to another organ, or portion of the body. Each carrier must be “acceptable” in the sense of being compatible with the other ingredients of the formulation.

The present invention also provides for the said vanadium based compound or any of its pharmaceutically acceptable salt thereof in the manufacture of a medicament adapted to trigger insulin signaling pathway, stimulate adipogenesis, block the inhibition of insulin activity by fatty acid, inhibition of NF-kB and fetuin-A expression increase the uptake of glucose by insulin target cells through the translocation of glucose transporter 4 (Glut 4) to the cell membrane to ameliorate type 1 and type 2 diabetic conditions.

The medicaments as described herein may be presented in unit dose forms containing a predetermined amount of the active ingredient per dose along with a pharmaceutically acceptable carrier. Such a unit may be adapted to provide 140-180 μg/day of the compound, preferably either 165 μg/clay in oral dose. Such doses can be provided in a single dose or as a number of discrete doses. The ultimate dose of course depends on the condition being treated, the route of administration such as (i) oral administration, for example, drenches (aqueous or non-aqueous solutions or suspensions), tablets, boluses, powders, granules, solution, capsules pastes for application through oral route.

The tablets, and other solid dosage forms of the pharmaceutical compositions of the present invention, such as dragees, capsules, pills and granules, may optionally be considered to include scored or prepared with coatings and shells, such as enteric coatings and other coatings well known in the pharmaceutical-formulating art. They may also be formulated so as to provide slow or controlled release of the active ingredient therein using, for example, hydroxypropylmethyl cellulose in varying proportions to provide the desired release profile, other polymer matrices, liposomes and/or microspheres. They may be sterilized by, for example, filtration through a bacteria-retaining filter, or by incorporating sterilizing agents in the form of sterile solid compositions which can be dissolved in sterile water, or some other sterile injectable medium immediately before use. These compositions may also optionally contain opacifying agents and may be of a composition that they release the active ingredient(s) only, or preferentially, in a certain portion of the gastrointestinal tract, optionally, in a delayed manner. Examples of embedding compositions which can be used include polymeric substances and waxes. The active ingredient can also be in micro-encapsulated form, if appropriate, with one or more of the above-described excipients. Liquid dosage forms for oral administration of the compounds of the invention include pharmaceutically acceptable emulsions, microemulsions, solutions, suspensions, syrups and elixirs.

It is found by way of the present invention that Streptozotocin (STZ), a toxicant which destroys islets of pancreas induces type 1 diabetes, treated diabetic rats restored their normal glucose level when treated with vanadium compound [VO(O₂)₂dmpz]. The results were further confirmed with genetically modified type 2 diabetic db/db mice and with major insulin target cells i.e. L6 myotubes and 3T3-L1 adipocytes. Interestingly, the vanadium compound of the present invention alone stimulated the insulin signaling pathway leading to glucose uptake in the absence of insulin.

The insulin signaling pathway has been impersonated by the vanadium compound [VO(O₂)₂ dmpz] of the present invention just like insulin in both skeletal muscle and 3T3-L1 cell lines with the same dose as insulin (100 nM). Skeletal muscle cell and adipocytes are major insulin target cells. The said vanadium compound augmented insulin receptor tyrosine phosphorylation that transduct signal leading to Akt phosphorylation and Glut-4 migration to the cell membrane. Such a clear augmentation of insulin signaling pathway starting from insulin receptor tyrosine kinase to Glut-4 translocation has not yet been demonstrated by other prior art vanadium based compounds. Surprisingly, the vanadium compound [VO (O₂)₂ dmpz] provided by way of the present invention plays an important role in adipogenesis. 3T3-L1 preadipocytes when treated with 5 μg/ml of vanadium compound for 7 days induced differentiation of preadipocyte to mature adipocytes that was further confirmed by the Oil red O experiment. Over expression of PPARγ by the compound of the invention is another remarkable claim which no other vanadium compound has demonstrated. In fact, except dexamethasone, IBMX and insulin, stimulation of adipogenesis could not be effected by any other compound in the art. Also another most interesting feature of the said novel vanadium compound of the present invention is its decrease of blood glucose level in leptin receptor deficient db/db mice. The said compound significantly reduces blood glucose level and also has another target; wherein it inhibits fetuin-A (a2-Heremans Schmid glycoprotein [Ahsg]) expression, an endogenous inhibitor of insulin receptor tyrosine kinase phosphorylation which abrogates insulin-stimulated downstream signals and is primarily synthesized in human liver and secreted into serum. Fetuin-A has recently been shown to damage adipocyte activity thereby reducing the uptake of lipid that results in hyperlipidemic condition that causes insulin resistance. This vanadium compound suppress the fetuin-A expression, therefore prevented fetuin-A's hazardous effect. In human being said fetuin-A, is known to be associated with insulin resistance and type 2 diabetes.

Despite fetuin-A's classical inhibitory effect on insulin resistance through the downregulation of insulin receptor activity, its association with the impairment of adipogenesis may also be an additional factor that amplifies fetuin-A's attenuating effect on insulin activity thus aggravating insulin resistance. Interestingly, the vanadium compound [VO (O₂)₂ dmpz] of the present invention strongly inhibited fetuin-A expression, thereby offering yet another important means to deal with insulin resistance.

The details of the invention and its advantages including objects are explained below in greater detail in connection to non-limiting exemplary illustrations according to the following examples.

### EXAMPLES

### Example 1

### Synthesis and Characterization of Oxodiperoxo-Dmpz-Vanadates (dmpz=3, 5 dimethylpyrazole)

The complexes DmpzH[VO(O₂)₂(dmpz)] (1), K[VO(O₂)₂(dmpz)], and Na₂[V₂O₂(O₂)₄(dmpz)] (3), were synthesized from aqueous solutions. Typically V₂O₅ or AVO₃ (A=Na, K etc.) was reacted with dimethyl pyrazole (dmpz) and hydrogen peroxide at a pH ca. 5 or 5.5 to afford yellow crystalline and microcrystalline compounds.

### Synthesis of Most Preferred Insulin Mimetic DmpzH[VO(O₂)₂(Dmpz)] (1):

To an aqueous solution of 0.5 gm (2.76 mmol) of vanadium pentaoxide V₂O₅ in 5 ml of water, 2 ml (27 mmol) of 46% hydrogen peroxide was taken in a pre-cooled (ca 0° C.) 100 ml beaker. The reaction mixture being maintained at ca 0° C. was stirred till the dissolution of all V₂O₅ and the solution became reddish-brown. To the clear solution dmpz was added maintaining the ratio of V:dmpz as 1:2.4. The pH of the solution at this stage was recorded to be ca. 5.5. It was stirred for 3 hours at ice cold condition and ethanol was added to initiate the precipitation and the product was obtained as bright yellow crystals. Well formed rod-shaped yellow crystals suitable for XRD analysis was obtained after two months from very dilute mother liquor. Yield of the product was 1.45 g (81%).

### Example 2

### Estimation of Glucose Uptake by Using Radiolabelled [³H]-2-deoxyglucose (2-DOG)

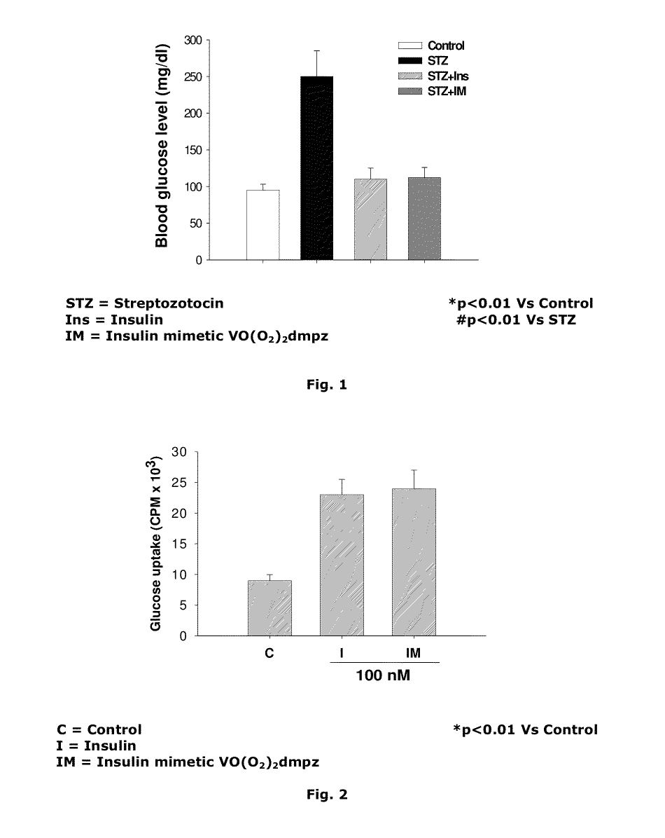

Insulin regulation of blood sugar level is orchestrated by number of signaling molecules that finally activate glucose transporter protein to be translocated to the membrane resulting glucose entry into the cell. The vanadium compound [VO(O₂)₂dmpz] of the present invention was investigated to determine glucose uptake into L6 skeletal muscles cell line (skeletal muscle cells are one of the major insulin target cells) wherein radiolabelled [³H]-2-deoxyglucose (2-DOG) was used to estimate the glucose uptake. Both insulin and the vanadium compound of the present invention independently increased the uptake to more than 2.5 fold over the control. Therefore, insulin and the said vanadium compound of the present invention enhanced glucose entry almost equi-potentially since both were used in similar concentration (FIG. 2). In addition to the abovesaid, fatty acid inhibition of insulin stimulation of 2-DOG uptake remains preserved by the said vanadium compound suggesting its efficacy in dealing insulin resistance.

### Example 3

### Stability Studies of Oxodiperoxo-Dmpz-Vanadates

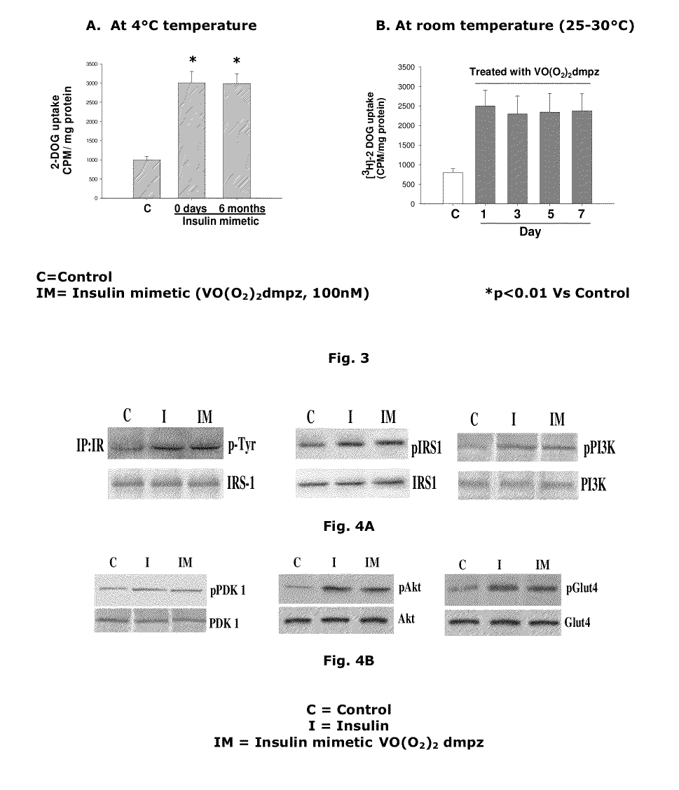

As mentioned before, insulin like activity of vanadium compound could not be utilized till date because of instability related issues. Vanadium compounds, demonstrating insulin enhancing activity or insulin mimetic activity are usually extremely labile to temperature and therefore have to be stored at very low temperature which created problems for its transport and use. On the other hand, the vanadium compound [VO(O₂)₂dmpz] of the present invention is stable at 4° C. for 6 months (FIG. 3A) and 10 days at room temperature (FIG. 3B). This remarkable advantage of the said vanadium compound [VO(O₂)₂ dmpz] of the present invention under study would thus permit easy transportation, storage and use.

### Example 4

### Sensitivity Studies of Oxodiperoxo-Dmpz-Vanadates

Another important advantage of this new vanadium compound [VO(O₂)₂dmpz] is its high sensitivity. It induces insulin like activity at much lower dose than the compounds reported so far. Table 1 hereunder illustrates elevation of glucose uptake at 100 nM dose level in skeletal muscle cells (in-vitro) and decreased blood glucose level in hyperglycemic rat at 0.5 μM/kg BW dose (in-vivo) as compared to other insulin mimetic already known in the art.

TABLE 1
Comparison of doses of different Vanadium compounds in-vitro and
in-vivo

| Name of the | Dose | | |
|---|---|---|---|
| compound | in-vitro | | References |
| L-Glut(g)HXM | 40 | μM | I Goldwaser, JBC, 1999 |
| Vanadate | 10 μM-100 | μM | N Shekar, Endocrinology, |
| | | | 1999, B. Lu, JBC, 2001 |
| pervanadate | 1 | mM | G. Huyer, JBC, 1997 |
| BMOV | 5-25 | μM | C. M. Krejsa, JBC, 1997 |
| bpV | 100 | μM | L. A. Nolte, Diabetes, 2003 |
| B6V10 | 5-100 | μM | S. G. Vicente, Diabetes, 2007 |
| Insulin mimetic | 100 | nM | Present invention |
| [VO(O2)2 dmpz] | | | |
| | Dose/kg | | |
| Name of the | body weight; | | |
| compound | in-vivo | | References |
| Vanadyl sulfate | 100 | mg | R. Yanardag, MCB, 2006 |
| BFOV | 0.2 | mM | L. H. Gao, Clinica Chemica |
| | | | Acta, 2006 |
| BMOV | 0.1 | mM | A. Mohammad, MCB, 2002 |
| B6V10 | 2.5 | μM | S. G. Vicente, Diabetes, 2007 |
| Insulin mimetic | 0.5 | μM | Present invention |
| [VO(O2)₂ dmpz] | | | |

### Example 5

### Studies on Augmentation of Both Upstream and Downstream Insulin Signaling Pathway

Binding of insulin to its heterotetrameric membrane receptor in target cells results in insulin receptor substrate 1 (IRS1) phosphorylation and IRS-1 associated phosphatidylinositol 3-phosphate kinase (PI3 kinase) activation which in turn activates serine/threonine kinases i.e., phosphatidylinositide-dependent kinase 1 (PDK-1) and protein kinase B or Akt. Akt then plays an important role by linking Glut 4 (glucose transporter 4) to insulin transduction pathway and effected glucose entry into the cells. Interestingly, the vanadium compound [VO (O₂)₂ dmpz] of the present invention significantly augmented both upstream and downstream insulin signaling pathway in almost similar range with same concentration as insulin as illustrated in FIGS. 4A and 4B. However, augmentation of insulin signaling pathway with such a low concentration of vanadium compound (100 nM) is a technical advancement amidst other vanadium compounds known in the art.

### Example 6

### In Vitro Assay of Glut 4 Translocation by Oxodiperoxo-Dmpz-Vanadates

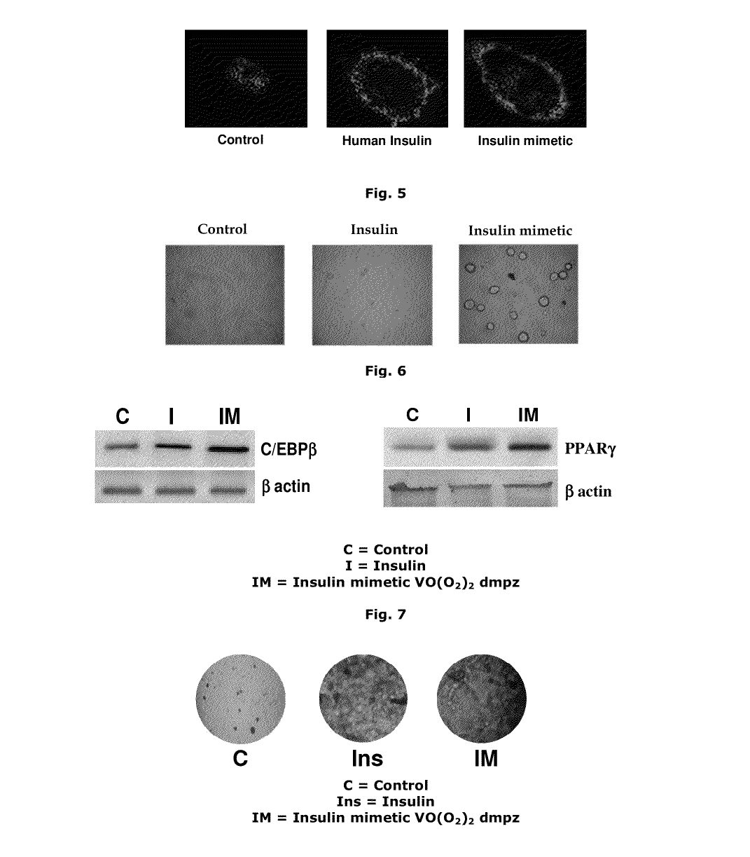

The most dependable in vitro assay for the detection of insulin activity is Glut 4 mobility to the cell membrane was employed (which is the final step of insulin signaling pathway for the entry of glucose), by transfecting a GFP-Glut4 gene in a plasmid to 3T3-L1 adipocytes as it facilitates to monitor the trafficking of Glut4 from cytosol to membrane with the help of GFP fluorescence tag. FIG. 5 reveals that Glut4 initially located in the cytosol and it gets translocated to the membrane on addition of insulin. Interestingly and similarly, the vanadium compound [VO (O₂)₂ dmpz] alone translocated Glut4 to the membrane as was observed in the case of insulin. Glut4 is a vital transporter of glucose in insulin target cells i.e., skeletal muscle cells and adipocytes. Both insulin and [VO (O₂)₂ dmpz] was individually capable of translocating Glut-4 to the membrane of insulin target cells, and surprisingly with equal potentiality. The said illustrated function of the vanadium compound of the present invention in the absence of insulin therefore concludes that it mimics insulin activity with equal strength so far as glucose transport is concerned. It may be mentioned that in diabetic patients Glut-4 trafficking is significantly less than non-diabetic human being.

### Example 7

### Expression of Crucial Adipogenic Factors C/EBPβ and PPARγ by the Oxodiperoxo-Dmpz-Vanadates

Adipogenesis or adipocyte differentiation is a crucial process in regulating lipid accumulation within adipocytes which is related to insulin resistance and type 2 diabetics. It is well known that excess of lipid in circulation leads insulin resistance and type-2 diabetes. The only cell that uptakes fatty acids and stores them are adipocytes, wherein dysfunction of said adipocytes cause elevated level of fatty acids in circulation and followed by deposition of lipid leading to obesity which are known factors affecting type-2 diabetes. Adipocytes originate from pluripotential stem cell that transforms to mesenchymal precursor cell that then transforms to preadipocyte. Differentiation of preadipocytes to mature adipocytes is a major event which is regulated by two important adipogenic factors—C/EBPβ and PPARγ. The vanadium compound of the present invention induces adipocyte differentiation from preadipocyte to mature adipocyte far more efficiently than insulin as illustrated in FIG. 6. C/EBPβ and PPARγ are crucial adipogenic factor and expression of both was significantly augmented by the vanadium compound of the present invention as illustrated in FIG. 6, demonstrating adipogenic function of [VO(O₂)₂ (dmpz)]. Thus the said vanadium compound of the invention was more effective than insulin wherein stimulation of adipogenesis itself is an indication for the prevention of insulin resistance.

### Example 8

### Stimulation of Adipocyte Function by Oxodiperoxo-Dmpz-Vanadates

To explore the stimulation of adipocyte function by the said vanadium compound of the present invention, 3T3-L1 preadipocytes were cultured in DMEM medium. This was followed by the determination of lipid content in the adipocyte with the help of oil red O staining. There was a significant increase in lipid droplet size and numbers in the adipocytes incubated with the vanadium compound of the present invention. Similar activity was detected with insulin however; the increase was significantly more prominent in case of the said vanadium compound.

### Example 9

### Intervention of Fetuin-A Mediated Inhibition of Adipocyte Function by Oxodiperoxo-Dmpz-Vanadates

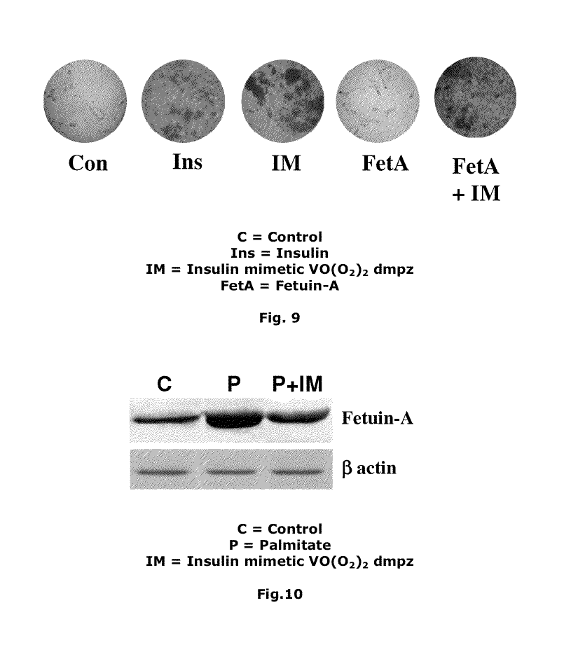

Fetuin-A (α2 Heremans schimid glycoprotein [Ahsg]) is synthesized in liver and secreted into the serum. Fetuin-A has recently been shown by many to be an endogenous inhibitor of insulin activity as it inhibits insulin receptor tyrosine kinase phosphorylation and thus abrogates insulin-stimulated downstream signals. Fetuin-A expression and its damage to adipocyte function leading to aggravation of insulin resistance has been currently reported in 1. Suman Dasgupta et al, in Biochem. J. (2010) 429, 451-462. Investigating the compound of the present invention on fetuin-A mediated inhibition of adipocyte function, it was surprisingly found that inhibitory activity of fetuin-A on lipid uptake could be reduced effectively. Fetuin-A also decreased lipid droplet size and numbers which was strikingly prevented by the vanadium compound of the present invention (FIG. 9). To find the rationale behind this inhibition, series of experiments were conducted to observe whether fatty acid stimulated Fetuin-A secretion could be inhibited by the vanadium compound of the present invention and indeed it was found that the said vanadium compound significantly reduced palmitate stimulated Fetuin-A secretion that therefore protects inhibition of adipocyte function (FIG. 10). Prevention of Fetuin-A inhibition of insulin activity and protection of adipocyte function is a new dimension achieved by the vanadium compound of the present invention.

### Example 10

### Studies Related to the Dose of Oxodiperoxo-Dmpz-Vanadate as Selected for Oral Administration Effective for Lowering Blood Glucose Level

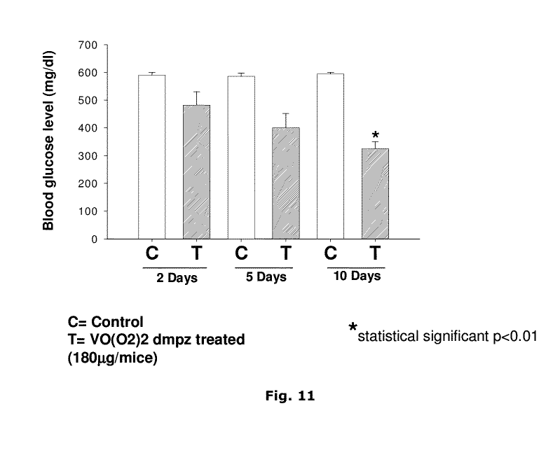

The most important part of the investigation was to include the examination of potentiality of the vanadium compounds of the present invention for protecting insulin resistance and type-2 diabetes. For this purpose type 2 diabetic db/db mice model was selected wherein the said db/db mice are genetically modified leptin receptor-deficient mice, wherein they are obese, highly insulin resistance and strongly hyperglycemic and thus regarded as ideal type 2 diabetic model. The db/db mice having a very high blood sugar level around 600 mg/dl were selected and the vanadium compound of the present invention was administered orally on different days as depicted in FIG. 11, which significantly reduced the blood glucose level (p<0.01). The dose used for this study was 180 μg/day/animal (each animal having body weight between 50-60 g). This was the lowest dose so far used in in-vivo experiments as compared to other vanadium based insulin mimetic compounds known in the art. Hence the vanadium compound of the present invention is highly sensitive and effective in regulating hyperglycemic condition in type 2 diabetes.

Thus above clearly and sufficiently demonstrates the provision by way of the present invention of a therapeutically active Vanadium compound which on one hand triggers insulin signaling pathway and also stimulate adipogenesis and also is capable of ameliorating type 1 and type 2 diabetic conditions and on the other hand is highly stable to benefit therapeutically stable and active applications/formulations involving the same for treatment of such conditions. The manufacture of the novel vanadium compound of the present invention is also simple and cost-effective facilitating the formulation of variety of oral, injectable and topical pharmaceutical compositions for the treatment of Diabetes mellitus. The most advantageous aspect of the said active principle of the present invention rests in its stability and its stability in formulations that does not lose its activity whereby favouring a long shelf life which is found a huge technical advancement in solving the problems and limitations of other vanadium compounds regarding stability which will be convenient for therapeutic application and thereof. The said active of the present invention also stimulates insulin signaling pathway in the absence of insulin indicating its strong insulin mimetic activity. Most importantly, the vanadium atom in its +5 oxidation state in combination with a bio-compatible ligand and peroxide in the insulin mimetic active of the present invention appears to be one of the best combinations to provide most effective target specific transportation for inducing insulin release and augmenting adipogenesis.

1. An insulin mimetic active comprising oxodiperoxo vanadates with vanadium in +5 oxidation state in combination with a bio-compatible ligand and peroxide selected from DmpzH[VO(O₂)₂](Dmpz)], K[VO(O₂)₂(dmpz)], Na₂[V₂O₂(O₂)₄(dmpz)] or other pharmaceutically acceptable salts of the vanadates preferably DmpzH[VO(O₂)₂](Dmpz)], wherein the (dmpz) is 3, 5 dimethylpyrazole favoring an effective target specific transportation for inducing insulin release and augmenting adipogenesis.

2. (canceled)

3. The insulin mimetic active as claimed in claim 1 which is stable in aqueous solution at room temperature for upto 10 days and at 4° C. in an ordinary refrigerator for upto six months without any loss of insulin mimetic activity.

4. The insulin mimetic active as claimed in claim 1 which is capable of at least one or more of:
(i) effectively reducing the blood glucose level (p<0.01) in hyperglycemic indications including type 2 diabetic db/db mice having very high blood sugar level even of 600 mg/dl;
(ii) stimulating insulin signaling pathway starting from the stimulation of insulin receptor tyrosine kinase to IRS-1, PI3K and PDK-1 eventually leading to the activation of PKB/Akt and Glut4 in skeletal muscles cell with the same dose as insulin thus indicative of equipotential insulin like activity;
(iii) stimulating the uptake of [³H]-2 deoxyglucose (2-DOG) in skeletal muscles cells in similar capacity as that of insulin thereby indicative of equipotential insulin like activity;
(iv) inducing Glut4 translocation from cytosol to cell membrane thereby facilitating the entry of glucose into the cells in skeletal muscles cell line in the same dose as of insulin indicative of equipotential insulin like activity even in the total absence of insulin;
(v) augmenting the expression of crucial adipogenic factors—C/EBPβ and PPARγ so as to regulate the differentiation of preadipocytes to mature adipocytes and also stimulating adipogenesis/adipogenic activity by enhancing accumulation and storage of lipid droplets in adipocytes resulted due to increased lipid uptake thereby reducing the lipid from circulation that prevent the development of insulin resistance; and
(vi) significantly reducing fetuin-A expression thus blocking fetuin-A inhibitory action thereby preventing endogenous Fetuin-A responsive damage to adipocyte function indicative of remarkable reduction in insulin resistance.

5. A pharmaceutical composition comprising:
(i) an insulin mimetic active comprising oxodiperoxo vanadates with vanadium in +5 oxidation state in combination with a bio-compatible ligand and peroxide selected from DmpzH[VO(O₂)₂](Dmpz)], K[VO(O₂)₂(dmpz)], Na₂[V₂O₂)₄(dmpz)] or other pharmaceutically acceptable salts of the vanadates preferably DmpzH[VO(O₂)₂](Dmpz)], wherein the (dmpz) is 3, 5 dimethylpyrazole; and
(ii) one or more pharmaceutically effective amount of any pharmaceutically acceptable carrier.

6. (canceled)

7. The pharmaceutical composition as claimed in claim 5 obtained in an orally administrable form of drenches (aqueous or non-aqueous solutions or suspensions), tablets, boluses, powders, granules, solutions, capsules, and pastes for through oral route.

8. The pharmaceutical composition as claimed in claim 5 obtained in a parenterally administrable form including subcutaneous, intramuscular or intravenous injection, preferably as a sterile solution or suspension.

9. A method of manufacture of the insulin mimetic active as claimed in claim 1 comprising the steps of:
(a) providing a clear pre-cooled solution of vanadium pentaoxide and hydrogen peroxide;
(b) adding dimethylpyrazole to the pre-cooled and clear solution and stirring under ice-cold condition; and
(c) adding alcohol to the solution to thereby obtain the insulin mimetic active therefrom.

10. The method of manufacture of the insulin mimetic active as claimed in claim 9 wherein the step of obtaining the insulin mimetic active comprises the steps of:
(a) providing a suspension of vanadium pentaoxide in water;
(b) adding 40-45% hydrogen peroxide solution to the suspension under pre-cooled condition of 0° C. and stirring until the complete dissolution of the vanadium pentaoxide to yield a reddish-brown clear solution;
(c) adding dimethylpyrazole to the clear solution maintaining the ratio of V:dmpz of about 1:2.4 and the pH of from 5-6 and stirring for about 3 hours under ice cold condition; and
(d) adding alcohol preferably ethanol to precipitate the insulin mimetic active therefrom.

11. A method of stimulating insulin signalling pathway starting from the augmentation of insulin receptor tyrosine kinase to IRS-1, PI3K and PDK-1 eventually leading to the activation of PKB/Akt and Glut4 in a mammal in need thereof in classic insulin target cell such as skeletal muscle cells comprising:
administering to the mammal in therapeutically effective formulation and 1 amount of the insulin mimetic active as claimed in claim 1.

12. A method of inducing Glut4 translocation from cytosol to cell membrane thereby facilitating the entry of glucose into the insulin target cells in a mammal in need thereof comprising:
administering to the mammalian cells a therapeutically effective formulation and amount of the insulin mimetic active ingredient as claimed in claim 1.

13. A method of preventing insulin resistance for the treatment of type-2 diabetes in a mammal in need thereof by augmenting the expression of crucial adipogenic factors—C/EBPβ and PPARγ adapted to regulate the differentiation of preadipocytes to mature adipocytes and also thereby stimulating adipogenic activity by enhancing accumulation and storage of lipid droplets in adipocytes leading to increased lipid uptake thereby eliminating the lipid from circulation, comprising:
administering to the mammal in therapeutically effective formulation and amount of the insulin mimetic active as claimed in claim 1.

14. A method of reducing insulin resistance in classic insulin target cells in a mammal in need thereof through the reduction of fetuin-A expression thus blocking fetuin-A inhibitory effect on insulin activity preventing endogenous Fetuin-A responsive damage to adipocyte function comprising:
administering to the mammal in therapeutically effective formulation and amount of the insulin mimetic active as claimed in claim 1.

15. A method of using the insulin mimetic active comprising oxodiperoxo vanadates as claimed in claim 1 as an active ingredient in effective amounts for the manufacture of a medicament for treating Diabetes Mellitus including Type 1 and type 2 diabetic conditions.

16. An insulin mimetic active comprising oxodiperoxo vanadates with vanadium in +5 oxidation state in combination with a bio-compatible ligand and peroxide selected from DmpzH[VO(O₂)₂](Dmpz)], K[VO(O₂)₂(dmpz)], Na₂[V₂O₂(O₂)₄(dmpz)] or other pharmaceutically acceptable salts of the vanadates preferably DmpzH[VO(O₂)₂](Dmpz)], wherein the (dmpz) is 3, 5 dimethylpyrazole, pharmaceutical compositions obtained thereof and its use as medicament for treating Diabetes Mellitus including Type 1 and type 2 diabetic conditions substantially as herein described and illustrated with reference to the accompanying examples.
